(19) United States
(12) Patent Application Publication
(10) Pub. No.: US 2007/0045444 A1
(43) Pub. Date: Mar. 1, 2007

(54) Thermostat including set point number line

(75) Inventors: Tony Gray, Dublin, OH (US); John Gilman Chapman JR., Delaware, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/216,791

(22) Filed: Aug. 31, 2005

(51) Int. Cl. G05D 23/00; F23N 5/20

(52) U.S. Cl. 236/94; 236/46 R

(57) ABSTRACT

A thermostat temperature programming display system for a digital thermostat that provides a graphical illustration of the relationship between the heating, cooling, and ambient temperatures is provided. This display system illustrates this relationship as digital markers along a linear temperature set point line on the display. As a set point is varied, the digital marker moves along the set point line. The heating and cooling set point markers are bounded by one another in a variable relationship based on a user defined dead band temperature during an automatic change over mode of operation. Only an appropriate marker is illustrated on the set point line based on the operating mode of the thermostat.

### FIELD OF THE INVENTION

The present invention relates generally to digital thermostats, and more particularly to the display of temperature set point programming information on a digital thermostat.

### BACKGROUND OF THE INVENTION

Occupants of dwellings and commercial structures have long benefited from the inclusion of a heating, ventilating, and air conditioning (HVAC) system that regulates the temperature and humidity within the dwelling or structure. Traditionally, the thermostat that controlled this temperature regulating equipment was a fairly simple electromechanical device that was simply wired to a heating device and/or to a cooling device. Once installed, the user need only move a pair of slider switches, one for heat and one for cool, to set the heating and cooling temperatures desired.

These two slider switches would typically move two indicators along a linear, mechanical temperature scale on the thermostat. When adjusting the temperature on such a thermostat, the user was presented with a visual indication of the relationships among the heating set point, the cooling set point, and the ambient temperature because all three were shown as indicators on the same linear temperature line. Further, the linear nature of the indicators provided a visual reason why the heating set point could not rise above the cooling set point, and why the cooling set point could not drop below the heating set point. On such thermostats, once the heating set point slider came within a certain mechanical distance of the cooling set point slider, the heating set point slider either would stop moving, or would push the cooling set point slider along with it so that the minimum distance was maintained between the two.

The physical nature of these indicators provided immediate feedback to the user that there must be a minimum distance between the two set points, and that the two set points were not allowed to cross. Obviously, if the desired heating set point was set higher than the desired cooling set point, both the heating and cooling equipment could theoretically attempt to drive the ambient temperature to its respective set point. If this were to happen, the result would be that both the heating and cooling equipment would continue to run until the user corrected the erroneous set point situation.

Additionally, the provision of the three indicators on the same linear temperature line provided the user with a visual indication from which the user could intuit that moving the set point indicator beyond the ambient temperature indicator would activate or deactivate the appropriate heating or cooling equipment, depending on which slider switch was moved past the ambient temperature indicator.

Advances in control electronics have allowed the development of new, digital thermostats that have almost entirely replaced the older mechanical counterparts. These new digital thermostats may be programmed by a user to control the heating and cooling equipment in a much more energy efficient manner than the older electromechanical devices. These modern digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during days of the week. For example, such a digital thermostat may provide for one programmed operation during the week and a different programmed operation on weekends, to accommodate the different usage patterns of the occupants of that particular dwelling or structure.

Such digital thermostats allow a user to program the HVAC system to control the ambient temperature to a particular set point, typically displayed as a set of numeric digits, for example, 78° F. Because the display and control are digital, the temperature set points may be set and displayed at any specific temperature desired. No longer must a user judge at what specific temperature the thermostat is set by interpreting an indicator on a number line with mechanical graduations.

While specific digital information may be displayed when programming and reading the thermostat, the programming of these thermostats often only displays to the user the particular set point being adjusted. This, however, does not provide any indication to the user of the relationship among the adjusted set point, the other set point, or the ambient temperature itself. That is, the user is typically unaware when setting, for example, the heating set point where the cooling set point is currently programmed, or even what the ambient temperature currently is.

As a result, the user may inadvertently attempt to program a set point for one type of HVAC equipment that interferes with the set point for the other HVAC equipment. For example, the user may attempt to set the heating set point at 78° when the thermostat previously was programmed with a cooling set point at 76°. Similarly, the user may attempt to adjust one of the set points to either increase or decrease the ambient temperature within the dwelling without success. For example, the user may be cold and attempt to increase the heating set point to turn on the heating equipment by adjusting the heating set point temperature from 70° to 72°. However, if the ambient temperature, while feeling cool to the occupant, is actually currently at 73°, the user's attempt at turning on the heating equipment by bumping up the heating set point will not result in the heating equipment turning on.

A small subset of digital thermostats show both the heating and cooling set points and the ambient temperature at the same time. However, as with the other digital thermostats, this information is all displayed to the user only as numerical digits in different rows or columns with no graphical or other visual relationship among them. That is, this type of digital numeric display does not provide the same visual cues that were available on the older mechanical thermostats. As such, the user may still inadvertently attempt to set the heating and/or cooling set point at a temperature that would interfere with the proper operation of the heating and/or cooling equipment.

As an example, even though the digital display may show that the cooling temperature set point is set to 76°, the user may still attempt to set the heating temperature set point to 78° because the relationship between these two parameters is not made clear to the user. As a further example, if the cooling temperature set point is set to 72° and the user is cold, the user may inadvertently attempt to set the heating set point to 74°, not realizing that this would theoretically result in operation of both the heating and cooling equipment at the same time.

There exists, therefore, a need in the art for a temperature programming display system for a digital thermostat that provides a visual relationship between the heating set point, the cooling set point, and the ambient temperature at least when the user is configuring the digital thermostat.

The invention provides such a digital thermostat programming display system. These and other advantages of the invention, as well as additional inventive features, will be apparent from the description of the invention provided herein.

### BRIEF SUMMARY OF THE INVENTION

The present invention provides a new and improved digital thermostat. More particularly, the present invention provides a new and improved digital thermostat having a temperature programming display system that provides a visual relationship between the heating set point and/or the cooling set point and/or the ambient temperature. Even more particularly, the present invention provides a new and improved digital thermostat having a temperature program display system that provides the visual relationship on a graphical set point number line displayed on a user display screen.

In one embodiment of the present invention a digital thermostat is provided that includes a user display screen with the ability to display graphical elements thereon. In this embodiment the thermostat displays a temperature number line during at least the period when a user is programming the heating and/or cooling set points. Preferably, digital icons in the form of markers are positioned along this number line in the graphical display to indicate the current heating and/or cooling set points. An additional digital icon in the form of a marker is also displayed along the number line to represent the currently sensed ambient temperature. As the user adjusts one of the set points through the programming interface, its corresponding digital icon is repositioned or moves along the temperature number line. In one embodiment this digital number line and the corresponding digital icons representing the markers along the line are displayed in addition to the numeric digital display of the actual temperature set point.

This temperature programming display system graphically illustrates to the user when the digital icon corresponding to the temperature parameter being adjusted crosses over the ambient marker to turn on or off the heating or cooling equipment. This display system also graphically illustrates to the user when the temperature set point runs into the marker for the other set point when both are displayed on the same line, e.g., when the thermostat allows for automatic changeover between heating and cooling modes of operation.

In one embodiment of the present invention where the thermostat is set either to a heating mode or a cooling mode, only the appropriate temperature set point marker is displayed along the temperature number line along with the ambient temperature marker. This simplified display does not mislead the user to believe that the cooling equipment may turn on if the thermostat is set to the heating mode or vice versa.

In an embodiment of the present invention wherein the thermostat allows for automatic changeover between heating and cooling modes of operation, the display system of the present invention displays both the heating and cooling marker icons along the temperature line with the ambient temperature. Preferably, the two temperature set points are bound by each other, i.e., they cannot cross one another on the temperature line so as to end up with a heating temperature set point above the cooling temperature set point. This prevents continuous operation of both the heating and cooling equipment.

In one embodiment the minimum distance between the two temperature set point marker icons is representative of a user specified dead band temperature. This dead band temperature may also be varied by the user through the thermostat's programming interface. That is, these two icons are not held in a fixed relationship, but instead are held in a relationship set by the user, which relationship may vary along with the programming of the temperature dead band itself.

In one embodiment of the present invention, when one set point is moved to within the dead band temperature of the other, that set point cannot be moved further unless the user moves the other set point. In a further embodiment, when one set point is moved to within the dead band temperature of the other and the user attempts to move that set point further, the other set point moves in relation to maintain the user selected dead band distance.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention; and

FIGS. 2-5 illustrate user display screens generated by and usable with the embodiment of the thermostat of the present invention illustrated in FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

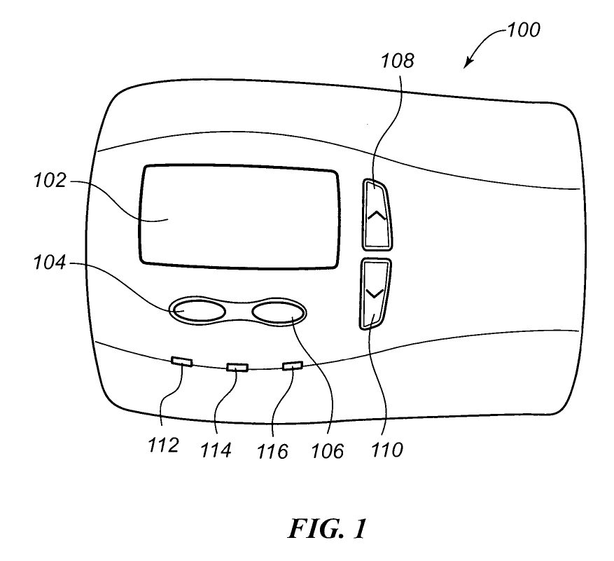

An embodiment of a thermostat constructed in accordance with the teachings of the present invention that incorporates the temperature programming display system of the present invention is illustrated in FIG. 1. As with many thermostats, an internal temperature sensor that is monitored by the internal processor is included within the thermostat 100. As may be seen from this FIG. 1, this embodiment of the thermostat 100 includes a user display 102 on which is displayed programmatic, system, and ambient information regarding the operation of the HVAC system. This user display 102 may take various forms as are well-known in the art, and in a preferred embodiment is a dot matrix LCD display. With such a display 102, the consumer may activate various programmatic and control functions via a pair of soft keys 104, 106. The functionality executed by these soft keys 104, 106 varies dependent upon the programmatic state in which the thermostat 100 is at the time one of the soft keys 104, 106 is depressed. The particular functionality that will be instituted upon selection of one of the soft keys 104, 106 is displayed in an area of the user display 102 proximate the key 104, 106 which will institute that function. That is, the function that will be instituted upon selection of soft key 104 will be located generally in the lower left hand portion of user display 102 while the functionality that will be instituted by selection of soft key 106 will be located generally in the lower right hand portion of user display 102. These functional indicators may change depending on the program state and mode in which the thermostat is currently operating.

In addition to the soft keys 104, 106, this embodiment of the thermostat 100 of the present invention also includes adjustment keys 108, 110. These adjustment keys 108, 110 may serve to adjust a currently selected parameter up or down, such as in the case of setting the control temperature at which the thermostat will maintain the ambient environment. This temperature setting operation will be described more fully below. Additionally, these keys 108, 110 may scroll through the available data for a selected parameter, such as scrolling through alphanumeric data that may be selected for a given parameter. These keys 108, 110 may also function as soft keys depending on the programmatic state in which the thermostat is operating. When this functionality is provided, the function that will be instituted by selection of key 108 will be provided generally in the upper right hand corner of display 102, while the functionality that will be instituted by selection of key 110 will be displayed generally in the lower right hand corner of user display 102. In addition to the above, other use input means, such as an alphanumeric keypad, user rotatable knob, a touch screen, etc. may be utilized instead of the buttons 104-110 illustrated in the embodiment of FIG. 1.

In this embodiment, the thermostat 100 also includes operating mode visual indicators 1112, 114, 116. These indicators 112-116 provide a visual indication of the current operating mode of the thermostat. In the embodiment illustrated in FIG. 1, indicator 112 will illuminate while the thermostat 100 is operating in the cooling mode. Indicator 116 will illuminate while the thermostat 100 is operating in the heating mode. Finally, indicator 114 will illuminate to indicate that the fan is operating. Depending on the particular application, this indicator 114 may illuminate whenever the fan is running, or may illuminate only when the fan is selected to run continuously.

In embodiments of the present invention that do not utilize automated switching control between the heating and cooling modes of operation, these indicators 112-116 may operate as user selectable switches to allow the consumer to select the operating mode of the thermostat 100. For example, during the summer months the consumer may select the cooling mode by depressing indicator 112. In this mode, the furnace will not be turned on even if the interior ambient temperature drops below the set point. To switch from the cooling to the heating mode of operation, the consumer, in this alternate embodiment, would need to select indicator 116 to allow the thermostat 100 to operate the furnace. Consumer selection in this embodiment of indicator 114 would operate the fan continuously, as opposed to its normal automatic operation based upon a call for cooling or heat by the thermostat 100. In a still further embodiment of the present invention, the indicators 112-116 may also be utilized to provide a visual indication of system trouble, or that there is a system reminder message being displayed on user screen 102.

Having discussed the physical structure of one embodiment of a thermostat 100 constructed in accordance with the teachings of the present invention, the discussion will now focus on the temperature programming display system which forms an aspect of the present invention. Indeed, while the following discussion will utilize the structure of the thermostat 100 illustrated in FIG. 1, those skilled in the art will recognize that various other structures can be utilized without departing from the spirit and scope of the present invention. That is, regardless of the user input mechanisms utilized by the particular embodiment of the thermostat 100 of the present invention, the programmatic steps and display information provided in the following discussion may be used.

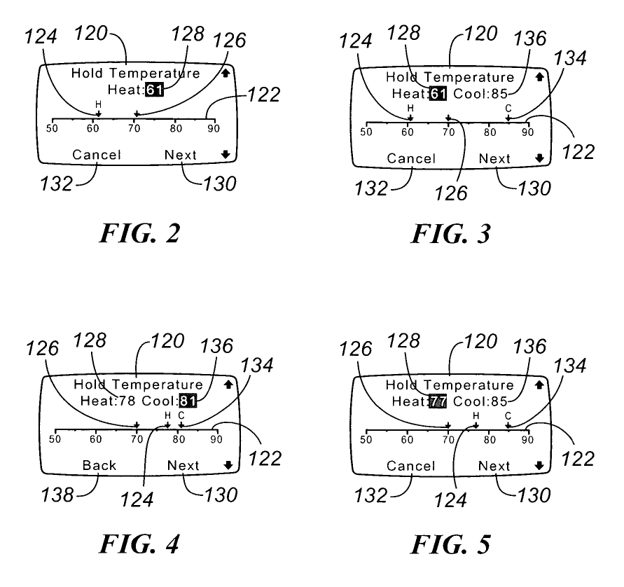

FIG. 2 illustrates an exemplary temperature programming screen 120 that may be displayed on the user interface 102 of the digital thermostat 100 illustrated in FIG. 1. Such a screen 120 may be displayed, in a preferred embodiment, upon user selection of a temperature programming function. It should be noted, however, that the particular items illustrated in each of the screen shots discussed herein are provided by way of example only, and in no way limit the scope of the invention. Such particular menu screens are provided merely to illustrate the inventive features of the present invention in its various forms.

When adjusting a temperature set point, the user is presented with a linear temperature line graphic 122 on the temperature programming screen 120. Displayed along this linear temperature line 122 are pointer icons or markers that graphically display the set point being adjusted, in this case the heating set point 124, and a marker indicating the current ambient temperature 126.

In the illustration of FIG. 2, the thermostat is set to the heating mode of operation, so only the heating set point 124 is illustrated on the linear temperature line 122 along with the ambient temperature 126. If the thermostat were set to the cooling mode of operation, in this embodiment, only the cooling set point would be displayed on the linear temperature line 122 in addition to the ambient temperature marker 126. This is unlike the old mechanical thermostats that always displayed both the heating and the cooling markers because these were physical items. However, since the digital thermostat 100 may be set to multiple modes of operation, e.g., a heating mode, a cooling mode, an automatic change over mode, etc., only those set point indicators that are relevant to the currently selected mode of operation need be displayed to the user. Displaying additional set point markers, when such markers would have no effect on the operation of the system, is precluded in the preferred embodiment of the present invention.

Continuing with the illustration of FIG. 2, the temperature programming screen 120 also displays the current set point temperature as a digital numeric display 128. As the user adjusts the set point temperature via, in the embodiment illustrated in FIG. 1, selection keys 108, 110, this change in set point is displayed numerically 128, and graphically as movement of marker 124 along the linear temperature line 122. In this way, the user is provided with the exact set point temperature in a numeric display 128 as well as what the relationship of this set point temperature is to the current ambient temperature.

Specifically, this is illustrated by the relationship between the set point marker 124 and the ambient temperature marker 126. In this way, the user may easily adjust the temperature set point so that the heating equipment begins to operate, without even knowing the actual ambient temperature, by simply adjusting the temperature set point marker 124 so that it passes the ambient temperature marker 126 along the linear temperature line 122. In previous digital thermostats wherein the temperature set point was only displayed numerically, the user could not be assured that the displayed adjustment would, in fact, begin the operation of the heating equipment as discussed in the example above. Similarly, the cooling equipment can be energized in a similar manner when the thermostat is set to the cooling mode, or either the heating or cooling equipment if set to the automatic change over mode as will be discussed more fully below.

Once the user has set the desired temperature via temperature programming screen 120, the user would simply select, in the embodiment of the thermostat 100 illustrated in FIG. 1, soft key 106 in proximity to the next functionality 130 to move to the next temperature set point, if such is provided by the thermostat, to be programmed. If, however, the user decides to cancel the adjustments made to this temperature set point, the user would simply depress soft key 104 in proximity to the cancel functionality 132 to abort the changes made to this temperature set point.

In one embodiment of the present invention, when the thermostat is set to an automatic change over mode of operation whereby it is in control of both the heating and cooling equipment, the temperature programming screen 120 illustrated in FIG. 3 will be displayed. As may be seen from the illustration of FIG. 3, in addition to the heating set point marker 124 illustrated as an arrow on the linear temperature line 122 with the “H” above it, the heat set point numeric display 128 and the ambient temperature marker 126, the temperature programming screen 120 now also includes the set point marker 134 for the cooling mode of operation. This marker 134 is displayed as an arrow on the linear temperature line 122 with the “C” above it. In a preferred embodiment, the screen 120 also includes the digital numeric display 136 of the cool set point temperature.

The programming corresponding to the temperature programming screen 120 illustrated in FIG. 3 will operate the heating and cooling equipment such that the heating equipment will turn on if the ambient temperature drops below 61° F., and the cooling equipment will turn on if the temperature rises above 85° F., depending of course on the user specified first stage differential and an additional un-adjustable offset. However, so long as the ambient temperature, represented by marker 126 remains between the heating set point marker 124 and the cooling set point marker 134, neither the heating nor the cooling equipment will be operated.

The programming of each of the heating and cooling set points are adjusted by the user as described above with regard to the programming of FIG. 2. That is, the user may adjust the heat set point via selection keys 108, 110. As the adjustments are made, both the digital numeric display 128 and the position of the heating set point marker 124 along the linear temperature line 122 will vary. Once the desired heating set point has been selected, the user depresses soft key 104 in proximity to the next functionality 130 to move to the cool set point adjustment. This adjustment is made in a similar fashion until the desired cool set point is achieved.

Unlike the temperature programming screen 120 illustrated in FIG. 2 wherein the thermostat was selected to the heating mode of operation and the heating set point was allowed to move freely along the linear temperature line 122 bounded only by the minimum and maximum temperatures allowed for a heating set point, the programming of the thermostat when set to the automatic change over mode of operation is different. That is, in this mode of operation the two temperature set points are bound by each other and one end point. In such a relationship, they cannot cross one another on the linear temperature line 122. This is to prevent the operation of both the heating and cooling equipment at the same time as may theoretically result if the heating set point were higher than the cooling set point.

In addition to being bound to one another, the two temperature set points are also constrained by a minimum distance between these two points on the linear number line 122. This minimum distance may vary, and is representative of the user specified dead band temperature. Unlike the previous mechanical thermostats which used a fixed mechanical linkage to separate the heat and cool slide switch indicators, the system of the present invention allows the user to set a desired dead band that is reflected as a variable distance between the markers 124, 134.

These relationships are illustrated in the temperature programming screen 120 illustrated in FIG. 4. In this FIG. 4, the thermostat is set to the auto change over mode of operation. The heat temperature set point 124 has been set to 78° F. As the user lowers the cool temperature set point illustrated graphically by marker 134 and numerically by the digital readout 136, a point is reached where the representative distance between the two markers 124, 134 on numeric line 122 reaches the user selected dead band temperature. In the embodiment illustrated in FIG. 4, it is assumed that the dead band temperature has been set by the user to be 3°. As such, the heating marker 124 and the cooling 134 cannot move closer together than as is illustrated in FIG. 4.

In one embodiment of the present invention, as the cooling set point temperature is lowered by the user, the heating set point temperature is also automatically lowered in relation thereto to maintain the user preset dead band temperature. This is illustrated graphically as both set point markers 124 and 134 will begin to slide along the numeric line 122 in a leftward direction as the cool set point temperature is lowered.

In an alternate embodiment of the present invention, the cooling set point temperature will not be allowed to be lowered any further since the user has previously set the heating set point temperature at a desired amount. In this alternate embodiment, the user would have to select soft key 104 in proximity to the back functionality 138 to adjust the heating set point temperature before the cooling set point temperature could be lowered.

That is, once the set point being adjusted reaches its boundary, the adjusted set point can either stop moving or it can push the other set point in the same direction so that in either embodiment the dead band distance between the two is maintained. In both embodiments, the user receives a visual indication of the relationship between the two set points 124, 134 along the linear temperature line 122.

Unlike the previous mechanical thermostats where the relationship between the heating and cooling set point markers were bound by a mechanical restriction that could not be altered by the user, the digital thermostat of the present invention allows the user to set the dead band temperature as simply another parameter in the programming interface. As such, the bounded relationship between the heating and cooling set point may be varied.

The temperature programming screen 120 illustrated in FIG. 5 illustrates such an adjustment to the dead band temperature as set by a user. In this illustration of FIG. 5, the user is attempting to raise the heating set point temperature with a user defined dead band of 8° F. Once the user raises the heating set point 124 to within 8° F. of the cooling set point 134, the heating set point 124 will either stop or begin to move the cooling set point temperature 134 in the same direction so as to maintain the user selected dead band temperature of 8° F. As discussed previously, this latter embodiment would result in the cooling marker 134 sliding along the linear temperature line 122 in a rightward direction as the heating temperature set point marker 124 is slid to the right along the linear temperature line 122. In this embodiment, the digital numeric display 128, 136 will each reflect these adjustments.

In a preferred embodiment of the present invention, a digital thermostat includes a temperature programming display system that generates graphical elements to display the relationship of the user selected parameters along a linear temperature line. Markers placed along this line indicate the current heating and/or cooling set points, depending on the operation mode of the thermostat, along with the ambient temperature. As the user adjusts one of the set points, its marker moves along the line. The user can see where the marker crosses over the ambient marker and when it runs into the marker for the other set point.

Since this display is digitally generated on a user display screen, it is not constrained in the same way that older mechanical slider switch thermostats were. Specifically, the display system may display only the set point that is appropriate to the selected mode of operation of the thermostat, including both the heating and cooling set points when appropriate, and can represent the various user selected dead band temperatures as a bounded relationship between the heating and cooling temperature set points. Further, the display system of the present invention also improves on the old mechanical slide switch thermostats by being able to display the exact digital value of the temperature set point in addition to the graphical display that illustrates the relationship between these set points.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A digital thermostat, comprising:
a user display screen; and
wherein the thermostat displays a temperature programming screen on the user display screen, the temperature programming screen including a temperature set point line, an ambient temperature digital pointer icon positioned in proximity to the temperature set point line at a position to indicate a sensed ambient temperature, and at least one temperature set point digital pointer icon positioned in proximity to the temperature set point line at a position to indicate at least one user programmed temperature set point.

2. The thermostat of claim 1, wherein the thermostat is set to operate in a heating mode of operation, and wherein the at least one temperature set point digital pointer icon comprises solely a heating set point marker positioned in proximity to the temperature set point line at a position to indicate a heating temperature set point.

3. The thermostat of claim 1, wherein the thermostat is set to operate in a cooling mode of operation, and wherein the at least one temperature set point digital pointer icon comprises solely a cooling set point marker positioned in proximity to the temperature set point line at a position to indicate a cooling temperature set point.

4. The thermostat of claim 1, wherein the thermostat is set to operate in an automatic change over mode of operation, and wherein the at least one temperature set point digital pointer icon comprises a heating set point marker positioned in proximity to the temperature set point line at a position to indicate a heating temperature set point and a cooling set point marker positioned in proximity to the temperature set point line at a position to indicate a cooling temperature set point.

5. The thermostat of claim 4, wherein the heating set point marker and the cooling set point marker are bounded by one another.

6. The thermostat of claim 5, wherein the heating set point marker and the cooling set point marker are constrained by a minimum distance between one another.

7. The thermostat of claim 6, wherein the minimum distance is graphically representative of a user set dead band temperature.

8. The thermostat of claim 7, wherein the minimum distance is variable in relation to changes in the user set dead band temperature.

9. The thermostat of claim 6, wherein user adjustment of a heating temperature set point results in corresponding movement of the heating set point marker along the temperature set point line, and wherein user adjustment of a cooling temperature set point results in corresponding movement of the cooling set point marker along the temperature set point line.

10. The thermostat of claim 9, wherein attempted movement of the heating set point marker to a position on the temperature set point line closer to the cooling set point marker than the minimum distance results in movement of the cooling set point marker to maintain the minimum distance and automatically adjusting the cooling set point temperature.

11. The thermostat of claim 9, wherein attempted movement of the cooling set point marker to a position on the temperature set point line closer to the heating set point marker than the minimum distance results in movement of the heating set point marker to maintain the minimum distance and automatically adjusting the heating set point temperature.

12. The thermostat of claim 9, wherein attempted movement of the heating set point marker to a position on the temperature set point line closer to the cooling set point marker than the minimum distance and attempted movement of the cooling set point marker to a position on the temperature set point line closer to the heating set point marker than the minimum distance is prohibited.

13. The thermostat of claim 1, wherein the temperature programming screen further includes at least one digital numeric display of the at least one user programmed temperature set point.

14. The thermostat of claim 2, wherein the at least one digital numeric display of the at least one user programmed temperature set point comprises solely a digital numeric display of the heating temperature set point.

15. The thermostat of claim 3, wherein the at least one digital numeric display of the at least one user programmed temperature set point comprises solely a digital numeric display of the cooling temperature set point.

16. The thermostat of claim 4, wherein the at least one digital numeric display of the at least one user programmed temperature set point comprises a digital numeric display of the heating temperature set point and a digital numeric display of the cooling temperature set point.

16. The thermostat of claim 13, further comprising user scrolling means for allowing a user to adjust both a value of the at least one digital numeric display of the at least one user programmed temperature set point and a position of the at least one temperature set point digital pointer icon along the temperature set point line.

17. A thermostat, comprising:
dot matrix user display screen; and
wherein the thermostat displays a temperature set point line on the user display screen and at least one temperature set point digital pointer icon positioned in proximity to the temperature set point line at a position to indicate at least one user programmed temperature set point.

18. The thermostat of claim 17, wherein the thermostat further displays on the user display screen an ambient temperature digital pointer icon positioned in proximity to the temperature set point line at a position to indicate a sensed ambient temperature.

19. The thermostat of claim 17, wherein the thermostat further displays on the user display screen at least one numeric display of the at least one user programmed temperature set point.

20. The thermostat of claim 17, wherein the thermostat displays solely the temperature set point corresponding to a current operating mode of the thermostat.
